(19) United States
(12) Patent Application Publication
(10) Pub. No.: US 2020/0024523 A1
(43) Pub. Date: Jan. 23, 2020

(54) HYDROLIQUEFACTION OF PETROLEUM COKE USING ALKALI METALS

(71) Applicant: Flint Hills Resources, LP, Wichita, KS (US)

(72) Inventors: William M. Cross, Jr., Wichita, KS (US); Clive Hamilton, Wichita, KS (US); Stephen Sanders, Wichita, KS (US)

(73) Assignee: Flint Hills Resources, LP, Wichita, KS (US)

(21) Appl. No.: 16/518,999

(22) Filed: Jul. 23, 2019

Related U.S. Application Data
(60) Provisional application No. 62/702,095, filed on Jul. 23, 2018.

(51) Int. Cl. C10G 1/08; C10G 1/00

(52) U.S. Cl. CPC C10G 1/086; B01J 23/04; C10G 1/002

(57) ABSTRACT

The present disclosure is directed toward processes for the hydroliquefaction and hydrodesulfurization of petroleum coke using alkali metal catalysts and/or tin co-catalysts.

### BACKGROUND

Due to the advent of low cost natural gas and the shale-gas revolution, petroleum coke has been subjected to increased pricing pressure. Additionally, sulfur and nitrogen levels of petroleum coke require it to price at a further discount.

Petroleum coke is generated using delayed coking or Flexicoker™ technology, where vacuum residue is processed to maximize recovery of fuel grade material, whilst rejecting excess carbon and sulfur in the solid petroleum coke. Beyond combustion for utility production, petroleum coke can also be gasified for the formation of carbon monoxide & hydrogen for subsequent production of chemicals or fuels. Unfortunately, such processing is highly capital intensive. One alternative, disclosed herein, is the direct hydroliquefaction of petroleum coke.

Hydroliquefaction, also called the Bergius process, has been used in the conversion of coal to fluid hydrocarbons. More specifically, hydroliquefaction has been used for substrates with feed hydrogen to carbon molar ratios of approximately 0.85 and higher with conversion rates up to ˜60-65%. Petroleum coke appeared not to be an ideal candidate for hydroliquefaction, due to its further lack of hydrogen and associated reaction requirements.

Petroleum coke may comprise up to 7% sulfur and has a hydrogen to carbon molar ratio of around 0.6. This ratio is below that of lignite, subbituminous, and bituminous coals. It is actually more similar to anthracite coal grades, where little liquefaction research has been conducted historically.

A new process to desulfurize and liquefy petroleum coke to higher value liquid hydrocarbons is disclosed.

### SUMMARY

Provided herein are processes for the hydroliquefaction and hydrodesulfurization of petroleum coke. In an aspect, provided herein is a process for the liquefaction of petroleum coke, the process comprising: a) mixing an alkali metal catalyst with a carrier fluid to produce a catalyst dispersion; and b) reacting the petroleum coke particles with the catalyst dispersion to afford fluid hydrocarbons. In an embodiment, the process further comprises grinding petroleum coke to produce petroleum coke particles.

In an embodiment, the petroleum coke contains less than 1% water by weight. In another embodiment the petroleum coke contains less than 0.5% water by weight. In yet another embodiment, the petroleum coke particles have an average particle size from about 2 to about 1000 μm. In still another embodiment, the petroleum coke particles have an average particle size from about 2 to about 100 μm. In an embodiment, the petroleum coke is generated as a byproduct of the refining of liquid petroleum. In another embodiment, the petroleum coke has a hydrogen to carbon molar ratio from about 0.4 to about 0.9. In yet another embodiment, the petroleum coke has a hydrogen to carbon molar ratio from about 0.45 to about 0.80. In still another embodiment, the petroleum coke has a sulfur content from about 1% to about 10%. In an embodiment, the petroleum coke has a sulfur content from about 1% to about 7%.

In an embodiment, the alkali metal catalyst comprises at least 90% elemental alkali metal by weight. In another embodiment, the alkali metal catalyst is sodium. In yet another embodiment, the alkali metal catalyst is delivered at about 100° C. In still another embodiment, the alkali metal catalyst is potassium. In an embodiment, the alkali metal catalyst is delivered at about 70° C.

In an embodiment, the catalyst dispersion contains from about 1% to about 10% metal by weight. In another embodiment, the catalyst dispersion further comprises a tin catalyst.

In an embodiment, step b) comprises high shear mixing. In another embodiment, the high shear mixing produces particles of alkali metal catalyst that have an average effective diameter of less than or equal to about 100 μm.

In an embodiment, the carrier fluid comprises a hydrocarbon or hydrocarbon mixture. In another embodiment, the hydrocarbon or hydrocarbon mixture has a normal boiling point greater than about 210° C. In yet another embodiment, the hydrocarbon or hydrocarbon mixture comprises paraffins or naphthenes. In still another embodiment, the carrier fluid is saturated with hydrogen gas.

In an embodiment, prior to step b), the petroleum coke particles are combined with the catalyst dispersion to form a coke slurry. In another embodiment, the coke slurry comprises from about 10% to about 60% petroleum liquids by weight. In yet another embodiment, the coke slurry comprises from about 90% to about 40% petroleum liquids by weight.

In an embodiment, step b) is performed in a continuously stirred tank reactor. In another embodiment, step b) comprises high shear mixing. In yet another embodiment, step b) is performed at a temperature from about 370° C. to about 470° C. In still another embodiment, step b) is performed at a temperature from about 400° C. to about 450° C. In an embodiment, step b) is performed at a pressure from about 500 psig to about 3000 psig. In another embodiment, step b) is performed at a pressure from about 800 psig to about 2000 psig. In yet another embodiment, step b) further comprises adding hydrogen gas at a partial pressure greater than or equal to about 300 psig.

In an embodiment, the ratio of catalyst dispersion to petroleum coke particles in step b) is such that the molar ratio of alkali metal in the catalyst dispersion to sulfur in the petroleum coke is greater than or equal to about 2:1. In another embodiment, the conversion of petroleum coke to fluid hydrocarbons is greater than about 50% by weight. In yet another embodiment, step b) reduces the sulfur content of the petroleum coke to afford desulfurized fluid hydrocarbons and sulfur byproducts. In still another embodiment, the sulfur byproducts comprise less than or equal to about 0.01% H₂S by weight. In an embodiment, the sulfur byproducts comprise levels of H₂S that are not detectable.

In another aspect, provided herein is a process for the liquefaction of petroleum coke, the process comprising: a) mixing an alkali metal catalyst with a first carrier fluid to produce a catalyst dispersion; b) mixing a tin catalyst with a second carrier fluid to produce a tin dispersion; and c) reacting the petroleum coke particles with the tin dispersion and the catalyst dispersion to afford fluid hydrocarbons.

### BRIEF DESCRIPTION OF THE DRAWINGS

FIG. 1: Schematic representation of petroleum coke liquefaction using alkali metals (Example 2).

FIG. 2: Schematic representation of petroleum coke liquefaction using alkali metals and a tin catalyst (Example 3).

### DETAILED DESCRIPTION

Provided herein are processes for the hydroliquefaction and hydrodesulfurization of petroleum coke. In an aspect, provided herein is a process for the liquefaction of petroleum coke, the process comprising: a) mixing an alkali metal catalyst with a carrier fluid to produce a catalyst dispersion; and b) reacting the petroleum coke particles with the catalyst dispersion to afford fluid hydrocarbons. In an embodiment, the process further comprises grinding petroleum coke to produce petroleum coke particles.

The current interest in petroleum coke conversion stems from the existing market drivers which have continued to solid fuels of high BTU value over the preference of natural gas. The challenge, thus, is dealing with both the high sulfur content and lower value of petroleum coke, as caused by the recent US shale gas revolution. Historically, technology providers have not focused on this petroleum coke opportunity. Rather for refining technology suppliers, the focus has been on research and development efforts directed at trying to process the coker feed, typically a full resid, upstream of a petroleum coker (i.e., resid hydrocracking research).

Although this is seemingly a simpler configuration and operation, a fundamental flaw in such thinking is that, for a refiner who has existing coking capacity, this is not a practical or economic investment alternative vs. dealing with petroleum coke conversion itself. The economic view addressed by the instant disclosure would be one of a sunk cost approach for the coker itself for most refiners, given this decision is already made. This provides a different vision to that of looking at “grass roots” refinery investments.

In particular this view illustrates that the key resid hydrocracker economic challenge is that such a process would necessitate more hydraulic capacity and investment over that of a future coker plus liquefaction configuration. Not only is initial investment challenging, but this alternative most often necessitates uneconomical consumption of catalyst materials which must constantly be swapped in and out of the unit.

Thus, one contribution herein is the identification of this fundamental need, that there exists an economic driver for a new high conversion petroleum coke liquefaction process. Thus, although a post-coker treatment process (coker plus liquefaction) involves a fundamentally more complex configuration option it may provide better economic returns, at conversion rates in excess of 50% conversion.

One can also note that some hydroliquefaction technologies do exist in the market today, particularly the process called H-coal™ and another variant of the well-known Bergius process, called Veba-combi-cracking. Neither of these technologies, however, have been shown to provide high levels of conversion of petroleum coke but rather have been directed at light coal or vac resid conversions, with higher hydrogen to carbon ratio feedstocks. Useful feeds for these processes include vac resid, lignite and bituminous coal (near 0.85 hydrogen to carbon ratio), and waste plastics. High conversion of carbonaceous materials like petroleum coke and anthracite coals, with hydrogen to carbon ratios of 0.6, is thus not well understood in this industry.

The present disclosure relates to the concept that petroleum coke, with hydrogen to carbon ratios as low as 0.58, can be converted into liquefied products at conversion rates of 50% and higher, using pressures less than 2000 psig and temperatures of 350° C. to 550° C., through the application of dry alkai metals catalysts and, to a greater extent, through the use of dry alkali metals in combination with a tin metal co-catalyst.

Herein, it is shown that petroleum coke may be liquefied at conversion levels up to approximately 70% liquefaction, using dry alkali metal and to a higher extent with dry alkali metals and tin metal. The process starts with (1) grinding & drying of the petroleum coke at temperatures above 150° C. The dried, ground petroleum coke, having particles sizes of 5-1000 micron, and more preferably 10-300 micron is blended with a carrier fluid. The carrier fluid is preheated and mixed with the ground petroleum coke to form a slurry. Slurry density is controlled into the process, and is targeted between 10% weight petroleum coke up to 60% weight petroleum coke and more preferably between 30-50% weight. Applicable process carrier fluids may comprise substantially hydrogenated (oxygen free) liquids or a hydrogen donating liquids and mixtures thereof, such as tetralin or similar carriers, as previous art has disclosed in U.S. Pat. No. 4,189,371. Target carriers have boiling point ranges between naphtha and light cycle oil, and more preferably in the range of jet and diesel. Preferably hydrogen is also added to the solvent, up to its liquid solvency level, prior to mixing with the petroleum coke. The mixed solvent/petroleum coke slurry is then added into a continuously stirred tank reactor (CSTR), for liquefaction.

In a separate vessel an alkali metal catalyst dispersion, comprising sodium or potassium, is made. For production of the dispersion, the use of high shear static mixing devices and a separate hydrocarbon carrier can be used. Methods know in the art, such as those highlighted in U.S. Pat. Nos. 2,635,041, 2,968,681, and 3,012,974 can also be applied. For produced dispersions using shear, the use of a heavier boiling point cut of material is preferred since the carrier viscosity will be increased, useful for shear. The alkali metal is introduced as a liquid and mixed the solvent. Mixing energy is applied to target an alkali metal particle size of between 0.5-100 micron and more preferably an average particle size between 2-50 micron. The alkali metal dispersion is then introduced into the CSTR.

In addition of the alkali metal dispersion, a tin metal dispersion can be formed and introduced into the reactor. Therein, a preheated tin metal (˜240-250° C.) is combined with an organic solvent carrier and dispersed using mechanical energy. The resulting dispersion is then introduced into the a CSTR reactor.

Two desired reactions take place within the CSTR, namely liquefaction via hydroconversion reaction and desulfurization. The alkali metal maybe introduced continuously or as in a semi-batch mode. Although, due to the high temperature reaction conditions, the actual reaction chemistry which occurs cannot be quantified, the reaction product compositions have offered some unique insight into what is likely to be occurring. First, it has been observed that the petroleum coke particles themselves become smaller as the liquefaction & desulfurization reactions are taking place. Secondly, it has been noted that at above stoichiometric ratios of sodium alkali metal to feed sulfur, further addition does not increase reaction rate of liquefaction. Rather we observe the production of a “sticky” intermediate components which is being formed, an intermediate with a carbon number >C40. This intermediate compound causes inherent mass transfer issues for the process given this “sticky” phase tends to agglomerate around areas within the vessel itself, leading to low shear zones, near the impeller, near wall baffles, and near the bottom of vessel.

It has been observed that no significant hydrogen sulfide is detected in the reaction products, when the alkali metal is run in excess of 2:1 alkali metal to sulfur. It has also been observed that the “sticky” material contains a significant quantity of chemically bound sodium associated with it, even after it has been water washed.

From these observations, the most prevalent reaction products are exclusive of H₂S, and most likely as the form or NaSH, NaH, Na₂S, R—S—Na, and R″—Na. Overall, it seems free sodium reacts at the petroleum coke surface potentially forming organosodium intermediates (R″—Na) or organosulfur intermediates (R—S—Na). As hydrogen is accessed, these intermediates can then be converted to resulting sodium hydrogen sulfide (NaSH) and sodium hydride (NaH), which can continue to react. NaSH remains reactive with potential to further form Na₂S. Sodium sulfide (Na₂S) is viewed to be much more stable and does not tend to as easily convert back to the more reactive sodium hydride form. As these reactions take place, the petroleum coke surfaces break apart, as sulfur is removed and carbon molecules are terminated with hydrogen.

Over time, sulfur is removed from the petroleum coke, freeing up available carbon radial sites, which either combine with available hydrogen or combined with available sodium alkali metal. Sodium sulfide production chemistry from dibenzothiophene is described by Sternberg et al., 1974. [Sternberg, H. et al. “Reaction of Sodium with Dibenzothiophene. A Method for Desulfurization of Residua”, Ind. Eng. Chem., Process Des. Develop, Vol. 13, No. 4, 1974.]

Therein, addition of Na into hydrocarbon feedstocks causes Carbon free-radicals to form. Na attacks Carbon bonds, but directionally has a higher affinity for sulfur than hydrocarbons. They illustrate that a theoretical molar ratio requirement of 4:1 Na/S is required without the use of hydrogen. With the use of Hydrogen, 2:1 Na to S is required. To terminate the carbon radial or Na-Carbon intermediate, a hydrogen source is needed. In the presence of hydrogen, these free radicals may be terminated. In the absence of hydrogen, it can be assumed that some free-radical polymerization can occur. Additionally, many alkali metals, particularly sodium, used for selectively hydrotreatment are known to have some propensity to foul and form higher carbon number intermediates.

The new observation based on the process described herein is that this coke formation is actually reversible through increased hydrogen availability, so these higher polymer reactions can be considered reversible. By measurement of the residual “sticky” intermediate phase, it is perceived that these higher molecular weight polymers contain sodium, likely the result of Na—C and Na—S—C intermediates. By controlling the reaction rates to that of the hydrogen mass transfer rates then the hydrogenation reaction and the alkali metal intermediate reactions can be adjusted to compete with one another more readily, in order to provide for liquefaction of higher carbon to hydrogen solids. As sulfur is removed, solid Na₂S product is formed terminating the free-radical reactions.

Available hydrogen may be added to the system by two means, either by (1) molecular gaseous hydrogen with pressure or (2) through hydrogen donation by a solvent. Since hydrogen donation is of primary interest, solvents with available hydrogen such as paraffins or naphthenes are desired. Aromatics solvents are not desired and will tend to reduce reaction rate. Additionally, higher operating pressures tend to be preferred.

In addition to solvents & hydrogen, high shear mixing with low to no reactor dead-zones is required to handle the transition from the solid petroleum coke phase through the “sticky” intermediate transition phase. It may be noted that this intermediate phase is actually a hydrotreatment catalyst, meaning that the remaining NaSH, R′—Na, R—S—Na, and Na₂S materials aid the hydrotreatment and associated liquefaction. This is similar to ExxonMobil's earlier art on Na₂S, where these materials are made in-situ. For the sodium system, one view is that a multitude of hydrotreatment catalysts (or chemically activity hydrogen transfer species) exist when alkali metal is added directly to the system.

For the sodium alkali metal, these include: Na, NaH, Na—SH, R′—SNa, Na₂S, and R″—Na, where R″—Na is the intermediate associated with “sticky” intermediate formation. Although potentially active R″—Na formation is a resultant of lack of hydrogen and once formed its accessibility may become more limited.

It has been observed that running the intended reactions in a batch or semi-batch system become onerous due to “sticky” system fouling. To counter this, it is thus preferred to run a system which manages continuous operations. Due to the “sticky” fouling nature of the system and desire to manage some of the alkali intermediates, start-up of a continuous system, however, requires development of some intermediates to help hydrotreatment. As such, it is preferable to bring the unit up slowly, with lower solids loading to start, and subsequently ramping up the initial solids feed charge. For instance, starting with a ˜10% wt petroleum coke to 90% solvent in the reactor (in order to help form desired intermediates form) and ramping to petroleum coke loading of ˜30-50% & ˜70-50% solvent, as net feed to the CSTR.

Additionally, to help drive hydrotreatment for the breakup of the intermediate phase, the addition of metallic tin co-catalyst into the reactor has been found to increase our liquefaction reaction rates. As the results provided herein indicate, tin seems to aid hydride transfer rates and manage the total “sticky” intermediate quantities thus increasing the total liquefaction yield. During these experiments and upon shutdown of the reactor it can be noted that the alkali metal, sodium, was not visually observed (bound as intermediates); however, a tin phase, separate and apart from that of the unconverted coke, was found as a separate solid phase when cooled.

### Definitions

Listed below are definitions of various terms used to describe this disclosure. These definitions apply to the terms as they are used throughout this specification and claims, unless otherwise limited in specific instances, either individually or as part of a larger group.

Unless defined otherwise, all technical and scientific terms used herein generally have the same meaning as commonly understood by one of ordinary skill in the art to which this disclosure belongs. Generally, the nomenclature used herein and the laboratory procedures in organic chemistry, inorganic chemistry, petrochemicals, and commodity chemicals are those well-known and commonly employed in the art.

As used herein, the articles “a” and “an” refer to one or to more than one (i.e., to at least one) of the grammatical object of the article. By way of example, “an element” means one element or more than one element. Furthermore, use of the term “including” as well as other forms, such as “include,” “includes,” and “included,” is not limiting.

As used in the specification and in the claims, the term “comprising” may include the embodiments “consisting of” and “consisting essentially of.” The terms “comprise(s),” “include(s),” “having,” “has,” “may,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated compounds, which allows the presence of only the named compounds, along with any other components which do not substantially change the makeup of the composition, and excludes other compounds.

All ranges disclosed herein are inclusive of the recited endpoint and independently combinable (for example, the range of “from 600 mg to 3000 mg” is inclusive of the endpoints, 600 mg and 3000 mg, and all the intermediate values, such as 2000 mg). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 600 to about 3000” also discloses the range “from 600 to 3000.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

### Methods

Provided herein are processes for the hydroliquefaction and hydrodesulfurization of petroleum coke. In an aspect, provided herein is a process for the liquefaction of petroleum coke, the process comprising: a) mixing an alkali metal catalyst with a carrier fluid to produce a catalyst dispersion; and b) reacting the petroleum coke particles with the catalyst dispersion to afford fluid hydrocarbons.

In an embodiment, the process further comprises grinding petroleum coke to produce petroleum coke particles. In an embodiment, the petroleum coke contains less than 5% water by weight. In another embodiment the petroleum coke contains less than 4% water by weight. In yet another embodiment, the petroleum coke contains less than 3% water by weight. In still another embodiment, the petroleum coke contains less than 2% water by weight. In an embodiment, the petroleum coke contains less than 1% water by weight. In another embodiment, the petroleum coke contains less than 0.5% water by weight. In yet another embodiment, the petroleum coke contains less than 0.1% water by weight.

In an embodiment, the petroleum coke particles have an average particle size from about 1 to about 1500 μm. In another embodiment, the petroleum coke particles have an average particle size from about 2 to about 1000 μm. In yet another embodiment, the petroleum coke particles have an average particle size from about 2 to about 100 μm. In still another embodiment, the petroleum coke particles have an average particle size of about 2 μm. In an embodiment, the petroleum coke particles have an average particle size of about 5 μm. In another embodiment, the petroleum coke particles have an average particle size of about 10 μm. In yet another embodiment, the petroleum coke particles have an average particle size of about 50 μm. In still another embodiment, the petroleum coke particles have an average particle size of about 100 μm. In an embodiment, the petroleum coke particles have an average particle size of about 150 μm. In another embodiment, the petroleum coke particles have an average particle size of about 200 μm.

In an embodiment, the petroleum coke is generated as a byproduct of the refining of liquid petroleum. In another embodiment, the petroleum coke has a hydrogen to carbon molar ratio from about 0.4 to about 0.9. In yet another embodiment, the petroleum coke has a hydrogen to carbon molar ratio from about 0.45 to about 0.80. In still another embodiment, the petroleum coke has a hydrogen to carbon molar ratio of about 0.45. In an embodiment, the petroleum coke has a hydrogen to carbon molar ratio of about 0.50. In another embodiment, the petroleum coke has a hydrogen to carbon molar ratio of about 0.55. In yet another embodiment, the petroleum coke has a hydrogen to carbon molar ratio of about 0.60. In still another embodiment, the petroleum coke has a hydrogen to carbon molar ratio of about 0.65. In an embodiment, the petroleum coke has a hydrogen to carbon molar ratio of about 0.70. In another embodiment, the petroleum coke has a hydrogen to carbon molar ratio of about 0.75. In yet another embodiment, the petroleum coke has a hydrogen to carbon molar ratio of about 0.80.

In an embodiment, the petroleum coke has a sulfur content from about 1% to about 15%. In another embodiment, the petroleum coke has a sulfur content from about 1% to about 10%. In yet another embodiment, the petroleum coke has a sulfur content from about 1% to about 7%. In still another embodiment, the petroleum coke has a sulfur content of about 1%. In an embodiment, the petroleum coke has a sulfur content of about 2%. In another embodiment, the petroleum coke has a sulfur content of about 3%. In yet another embodiment, the petroleum coke has a sulfur content of about 4%. In still another embodiment, the petroleum coke has a sulfur content of about 5%. In an embodiment, the petroleum coke has a sulfur content of about 6%. In another embodiment, the petroleum coke has a sulfur content of about 7%.

In an embodiment, the alkali metal catalyst comprises at least 90% elemental alkali metal by weight. In another embodiment, the alkali metal catalyst comprises at least 91% elemental alkali metal by weight. In yet another embodiment, the alkali metal catalyst comprises at least 92% elemental alkali metal by weight. In still another embodiment, the alkali metal catalyst comprises at least 93% elemental alkali metal by weight. In an embodiment, the alkali metal catalyst comprises at least 94% elemental alkali metal by weight. In another embodiment, the alkali metal catalyst comprises at least 95% elemental alkali metal by weight. In yet another embodiment, the alkali metal catalyst comprises at least 96% elemental alkali metal by weight. In still another embodiment, the alkali metal catalyst comprises at least 97% elemental alkali metal by weight. In an embodiment, the alkali metal catalyst comprises at least 98% elemental alkali metal by weight. In another embodiment, the alkali metal catalyst comprises at least 99% elemental alkali metal by weight.

In an embodiment, the alkali metal catalyst is selected from the group consisting of lithium, sodium, potassium, rubidium, cesium, and francium. In another embodiment, the alkali metal catalyst is sodium. In yet another embodiment, the alkali metal catalyst is potassium.

In an embodiment, the alkali metal catalyst is delivered at about 110° C. In another embodiment, the alkali metal catalyst is delivered at about 100° C. In yet another embodiment, the alkali metal catalyst is delivered at about 90° C. In still another embodiment, the alkali metal catalyst is delivered at about 80° C. In an embodiment, the alkali metal catalyst is delivered at about 70° C. In another embodiment, the alkali metal catalyst is delivered at about 60° C.

In an embodiment, the catalyst dispersion contains from about 1% to about 20% metal by weight. In another embodiment, the catalyst dispersion contains from about 1% to about 10% metal by weight. In another embodiment, the catalyst dispersion contains about 1% metal by weight. In yet another embodiment, the catalyst dispersion contains about 2% metal by weight.

In still another embodiment, the catalyst dispersion contains about 3% metal by weight. In an embodiment, the catalyst dispersion contains about 4% metal by weight. In another embodiment, the catalyst dispersion contains about 5% metal by weight. In yet another embodiment, the catalyst dispersion contains about 6% metal by weight. In still another embodiment, the catalyst dispersion contains about 7% metal by weight. In an embodiment, the catalyst dispersion contains about 8% metal by weight. In another embodiment, the catalyst dispersion contains about 9% metal by weight. In yet another embodiment, the catalyst dispersion contains about 10% metal by weight.

In an embodiment, the catalyst dispersion further comprises a p-block metal catalyst. In another embodiment, the catalyst dispersion further comprises a second catalyst selected from the group consisting of gallium, germanium, indium, tin, antimony, thallium, lead, and bismuth. In yet another embodiment, the catalyst dispersion further comprises a gallium catalyst. In still another embodiment, the catalyst dispersion further comprises a germanium catalyst. In an embodiment, the catalyst dispersion further comprises a indium catalyst. In another embodiment, the catalyst dispersion further comprises a tin catalyst. In yet another embodiment, the catalyst dispersion further comprises an antimony catalyst. In yet another embodiment, the catalyst dispersion further comprises a thallium catalyst. In still another embodiment, the catalyst dispersion further comprises a lead catalyst. In an embodiment, the catalyst dispersion further comprises a lead catalyst. In another embodiment, the catalyst dispersion further comprises a bismuth catalyst.

In an embodiment, step a) comprises mixing. In another embodiment, step a) comprises high shear mixing. In yet another embodiment, the high shear mixing in step a) is achieved through the use of a baffled-wall reactor and at least one impeller. In still another embodiment, the impeller is an upflow solids mixing impeller. In still another embodiment, the high shear mixing produces particles of alkali metal catalyst that have an average effective diameter of less than or equal to about 1000 μm. In an embodiment, the high shear mixing produces particles of alkali metal catalyst that have an average effective diameter of less than or equal to about 500 μm. In another embodiment, the high shear mixing produces particles of alkali metal catalyst that have an average effective diameter of less than or equal to about 250 μm. In yet another embodiment, the high shear mixing produces particles of alkali metal catalyst that have an average effective diameter of less than or equal to about 200 μm. In still another embodiment, the high shear mixing produces particles of alkali metal catalyst that have an average effective diameter of less than or equal to about 150 μm. In an embodiment, the high shear mixing produces particles of alkali metal catalyst that have an average effective diameter of less than or equal to about 125 μm. In another embodiment, the high shear mixing produces particles of alkali metal catalyst that have an average effective diameter of less than or equal to about 110 μm. In yet another embodiment, the high shear mixing produces particles of alkali metal catalyst that have an average effective diameter of less than or equal to about 100 μm. In still another embodiment, the high shear mixing produces particles of alkali metal catalyst that have an average effective diameter of less than or equal to about 90 μm. In an embodiment, the high shear mixing produces particles of alkali metal catalyst that have an average effective diameter of less than or equal to about 80 μm.

In an embodiment, the carrier fluid comprises a hydrocarbon or hydrocarbon mixture. In another embodiment, the carrier fluid has a normal boiling point in the light cycle oil to diesel boiling point range. In yet another embodiment, the hydrocarbon or hydrocarbon mixture has a normal boiling point greater than about 210° C. In still another embodiment, the hydrocarbon or hydrocarbon mixture comprises paraffins or naphthenes. In an embodiment, the carrier fluid comprises less than about 20% aromatics. In another embodiment, the carrier fluid comprises less than about 10% aromatics. In yet another embodiment, the carrier fluid comprises less than about 5% aromatics. In still another embodiment, the carrier fluid comprises less than about 1% aromatics. In an embodiment, the carrier fluid is saturated with hydrogen gas. In another embodiment, the carrier fluid is partially saturated with hydrogen gas.

In an embodiment, prior to step b), the petroleum coke particles are combined with the catalyst dispersion to form a coke slurry. In another embodiment, the coke slurry comprises from about 10% to about 60% petroleum liquids by weight. In yet another embodiment, the coke slurry comprises about 5% petroleum liquids by weight. In still another embodiment, the coke slurry comprises about 10% petroleum liquids by weight. In an embodiment, the coke slurry comprises about 20% petroleum liquids by weight. In another embodiment, the coke slurry comprises about 30% petroleum liquids by weight. In yet another embodiment, the coke slurry comprises about 40% petroleum liquids by weight. In still another embodiment, the coke slurry comprises about 50% petroleum liquids by weight. In an embodiment, the coke slurry comprises about 60% petroleum liquids by weight. In another embodiment, the coke slurry comprises about 70% petroleum liquids by weight. In yet another embodiment, the coke slurry comprises from about 90% to about 40% petroleum liquids by weight. In still another embodiment, the coke slurry comprises about 30% petroleum liquids by weight. In an embodiment, the coke slurry comprises about 40% petroleum liquids by weight. In another embodiment, the coke slurry comprises about 50% petroleum liquids by weight. In yet another embodiment, the coke slurry comprises about 60% petroleum liquids by weight. In still another embodiment, the coke slurry comprises about 70% petroleum liquids by weight. In an embodiment, the coke slurry comprises about 80% petroleum coke by weight. In another embodiment, the coke slurry comprises about 90% petroleum liquids by weight.

In an embodiment, step b) is performed in a continuously stirred tank reactor. In an embodiment, step b) comprises mixing. In another embodiment, step b) comprises high shear mixing. In yet another embodiment, the high shear mixing in step b) is achieved through the use of a baffled-wall reactor and at least one impeller. In still another embodiment, the impeller is an upflow solids mixing impeller.

In an embodiment, step b) is performed at a temperature from about 300° C. to about 500° C. In another embodiment, step b) is performed at a temperature from about 370° C. to about 470° C. In yet another embodiment, step b) is performed at a temperature from about 400° C. to about 450° C. In still another embodiment, step b) is performed at a temperature of about 400° C. In an embodiment, step b) is performed at a temperature of about 410° C. In another embodiment, step b) is performed at a temperature of about 420° C. In yet another embodiment, step b) is performed at a temperature of about 430° C. In still another embodiment, step b) is performed at a temperature of about 440° C. In an embodiment, step b) is performed at a temperature of about 450° C.

In an embodiment, step b) is performed at a pressure from about 500 psig to about 3000 psig. In another embodiment, step b) is performed at a pressure from about 800 psig to about 2000 psig. In yet another embodiment, step b) is performed at a pressure of about 800 psig. In still another embodiment, step b) is performed at a pressure of about 1000 psig. In an embodiment, step b) is performed at a pressure of about 1200 psig. In another embodiment, step b) is performed at a pressure of about 1400 psig. In yet another embodiment, step b) is performed at a pressure of about 1600 psig. In still another embodiment, step b) is performed at a pressure of about 1800 psig. In an embodiment, step b) is performed at a pressure of about 2000 psig.

In an embodiment, step b) further comprises adding hydrogen gas at a partial pressure greater than or equal to about 300 psig. In another embodiment, step b) further comprises adding hydrogen gas at a partial pressure of about 300 psig. In yet another embodiment, step b) further comprises adding hydrogen gas at a partial pressure of about 350 psig. In still another embodiment, step b) further comprises adding hydrogen gas at a partial pressure of about 400 psig. In an embodiment, step b) further comprises adding hydrogen gas at a partial pressure of about 500 psig. In another embodiment, step b) further comprises adding hydrogen gas at a partial pressure of about 600 psig. In yet another embodiment, step b) further comprises adding hydrogen gas at a partial pressure of about 700 psig. In still another embodiment, step b) further comprises adding hydrogen gas at a partial pressure of about 800 psig. In an embodiment, step b) further comprises adding hydrogen gas at a partial pressure of about 900 psig. In another embodiment, step b) further comprises adding hydrogen gas at a partial pressure of about 1000 psig. In yet another embodiment, step b) further comprises adding hydrogen gas at a partial pressure of about 1500 psig. In still another embodiment, step b) further comprises adding hydrogen gas at a partial pressure of about 2000 psig. In an embodiment, step b) further comprises adding hydrogen gas at a partial pressure of about 2500 psig. In another embodiment, step b) further comprises adding hydrogen gas at a partial pressure of about 3000 psig. In yet another embodiment, step b) further comprises adding hydrogen gas at a partial pressure of about 3500 psig. In still another embodiment, step b) further comprises adding hydrogen gas at a partial pressure of about 4000 psig. In another embodiment, step b) further comprises adding hydrogen gas at a partial pressure from about 300 psig to about 4000 psig.

In an embodiment, the ratio of catalyst dispersion to petroleum coke particles in step b) is such that the molar ratio of alkali metal in the catalyst dispersion to sulfur in the petroleum coke is greater than or equal to about 2:1. In another embodiment, the ratio of catalyst dispersion to petroleum coke particles in step b) is such that the molar ratio of alkali metal in the catalyst dispersion to sulfur in the petroleum coke is about 2:1. In yet another embodiment, the ratio of catalyst dispersion to petroleum coke particles in step b) is such that the molar ratio of alkali metal in the catalyst dispersion to sulfur in the petroleum coke is about 2.5:1. In still another embodiment, the ratio of catalyst dispersion to petroleum coke particles in step b) is such that the molar ratio of alkali metal in the catalyst dispersion to sulfur in the petroleum coke is about 3:1. In an embodiment, the ratio of catalyst dispersion to petroleum coke particles in step b) is such that the molar ratio of alkali metal in the catalyst dispersion to sulfur in the petroleum coke is about 3.5:1. In another embodiment, the ratio of catalyst dispersion to petroleum coke particles in step b) is such that the molar ratio of alkali metal in the catalyst dispersion to sulfur in the petroleum coke is about 4:1. In yet another embodiment, the ratio of catalyst dispersion to petroleum coke particles in step b) is such that the molar ratio of alkali metal in the catalyst dispersion to sulfur in the petroleum coke is about 4.5:1. In still another embodiment, the ratio of catalyst dispersion to petroleum coke particles in step b) is such that the molar ratio of alkali metal in the catalyst dispersion to sulfur in the petroleum coke is about 5:1. In an embodiment, the ratio of catalyst dispersion to petroleum coke particles in step b) is such that the molar ratio of alkali metal in the catalyst dispersion to sulfur in the petroleum coke is about 5.5:1. In another embodiment, the ratio of catalyst dispersion to petroleum coke particles in step b) is such that the molar ratio of alkali metal in the catalyst dispersion to sulfur in the petroleum coke is about 6:1. In yet another embodiment, the ratio of catalyst dispersion to petroleum coke particles in step b) is such that the molar ratio of alkali metal in the catalyst dispersion to sulfur in the petroleum coke is about 6.5:1. In still another embodiment, the ratio of catalyst dispersion to petroleum coke particles in step b) is such that the molar ratio of alkali metal in the catalyst dispersion to sulfur in the petroleum coke is about 7:1. In an embodiment, the ratio of catalyst dispersion to petroleum coke particles in step b) is such that the molar ratio of alkali metal in the catalyst dispersion to sulfur in the petroleum coke is about 7.5:1. In another embodiment, the ratio of catalyst dispersion to petroleum coke particles in step b) is such that the molar ratio of alkali metal in the catalyst dispersion to sulfur in the petroleum coke is about 8:1. In yet another embodiment, the ratio of catalyst dispersion to petroleum coke particles in step b) is such that the molar ratio of alkali metal in the catalyst dispersion to sulfur in the petroleum coke is from about 1:1 to about 8:1.

In an embodiment, the conversion of petroleum coke to fluid hydrocarbons is greater than about 50% by weight. In another embodiment, the conversion of petroleum coke to fluid hydrocarbons is about 55% by weight. In yet another embodiment, the conversion of petroleum coke to fluid hydrocarbons is about 60% by weight. In still another embodiment, the conversion of petroleum coke to fluid hydrocarbons is about 65% by weight. In an embodiment, the conversion of petroleum coke to fluid hydrocarbons is about 70% by weight. In another embodiment, the conversion of petroleum coke to fluid hydrocarbons is about 80% by weight. In yet another embodiment, the conversion of petroleum coke to fluid hydrocarbons is about 85% by weight. In still another embodiment, the conversion of petroleum coke to fluid hydrocarbons is about 90% by weight. In an embodiment, the conversion of petroleum coke to fluid hydrocarbons is about 95% by weight. In another embodiment, the conversion of petroleum coke to fluid hydrocarbons is about 100% by weight.

In an embodiment, step b) reduces the sulfur content of the petroleum coke to afford desulfurized fluid hydrocarbons and sulfur byproducts. In another embodiment, the desulfurized fluid hydrocarbons do not contain detectable levels of sulfur. In yet another embodiment, the sulfur byproducts comprise less than or equal to about 0.01% H₂S by weight. In still another embodiment, the sulfur byproducts comprise about 0.01% H₂S by weight. In an embodiment, the sulfur byproducts comprise less than about 0.01% H₂S by weight. In yet another embodiment, the sulfur byproducts comprise ppb levels of H₂S by weight. In an embodiment, the sulfur byproducts comprise levels of H₂S that are not detectable.

In another aspect, provided herein is a process for the liquefaction of petroleum coke, the process comprising: a) mixing an alkali metal catalyst with a first carrier fluid to produce a catalyst dispersion; b) mixing a tin catalyst with a second carrier fluid to produce a tin dispersion; and c) reacting the petroleum coke particles with the tin dispersion and the catalyst dispersion to afford fluid hydrocarbons.

In an embodiment, the petroleum coke contains less than 5% water by weight. In another embodiment the petroleum coke contains less than 4% water by weight. In yet another embodiment, the petroleum coke contains less than 3% water by weight. In still another embodiment, the petroleum coke contains less than 2% water by weight. In an embodiment, the petroleum coke contains less than 1% water by weight. In another embodiment, the petroleum coke contains less than 0.5% water by weight. In yet another embodiment, the petroleum coke contains less than 0.1% water by weight.

In an embodiment, the petroleum coke particles have an average particle size from about 1 to about 1500 μm. In another embodiment, the petroleum coke particles have an average particle size from about 2 to about 1000 μm. In yet another embodiment, the petroleum coke particles have an average particle size from about 2 to about 100 μm. In still another embodiment, the petroleum coke particles have an average particle size of about 2 μm. In an embodiment, the petroleum coke particles have an average particle size of about 5 μm. In another embodiment, the petroleum coke particles have an average particle size of about 10 μm. In yet another embodiment, the petroleum coke particles have an average particle size of about 50 μm. In still another embodiment, the petroleum coke particles have an average particle size of about 100 μm. In an embodiment, the petroleum coke particles have an average particle size of about 150 μm. In another embodiment, the petroleum coke particles have an average particle size of about 200 μm.

In an embodiment, the petroleum coke is generated as a byproduct of the refining of liquid petroleum. In another embodiment, the petroleum coke has a hydrogen to carbon molar ratio from about 0.4 to about 0.9. In yet another embodiment, the petroleum coke has a hydrogen to carbon molar ratio from about 0.45 to about 0.80. In still another embodiment, the petroleum coke has a hydrogen to carbon molar ratio of about 0.45. In an embodiment, the petroleum coke has a hydrogen to carbon molar ratio of about 0.50. In another embodiment, the petroleum coke has a hydrogen to carbon molar ratio of about 0.55. In yet another embodiment, the petroleum coke has a hydrogen to carbon molar ratio of about 0.60. In still another embodiment, the petroleum coke has a hydrogen to carbon molar ratio of about 0.65. In an embodiment, the petroleum coke has a hydrogen to carbon molar ratio of about 0.70. In another embodiment, the petroleum coke has a hydrogen to carbon molar ratio of about 0.75. In yet another embodiment, the petroleum coke has a hydrogen to carbon molar ratio of about 0.80.

In an embodiment, the petroleum coke has a sulfur content from about 1% to about 15%. In another embodiment, the petroleum coke has a sulfur content from about 1% to about 10%. In yet another embodiment, the petroleum coke has a sulfur content from about 1% to about 7%. In still another embodiment, the petroleum coke has a sulfur content of about 1%. In an embodiment, the petroleum coke has a sulfur content of about 2%. In another embodiment, the petroleum coke has a sulfur content of about 3%. In yet another embodiment, the petroleum coke has a sulfur content of about 4%. In still another embodiment, the petroleum coke has a sulfur content of about 5%. In an embodiment, the petroleum coke has a sulfur content of about 6%. In another embodiment, the petroleum coke has a sulfur content of about 7%.

In an embodiment, the alkali metal catalyst comprises at least 90% elemental alkali metal by weight. In another embodiment, the alkali metal catalyst comprises at least 91% elemental alkali metal by weight. In yet another embodiment, the alkali metal catalyst comprises at least 92% elemental alkali metal by weight. In still another embodiment, the alkali metal catalyst comprises at least 93% elemental alkali metal by weight. In an embodiment, the alkali metal catalyst comprises at least 94% elemental alkali metal by weight. In another embodiment, the alkali metal catalyst comprises at least 95% elemental alkali metal by weight. In yet another embodiment, the alkali metal catalyst comprises at least 96% elemental alkali metal by weight. In still another embodiment, the alkali metal catalyst comprises at least 97% elemental alkali metal by weight. In an embodiment, the alkali metal catalyst comprises at least 98% elemental alkali metal by weight. In another embodiment, the alkali metal catalyst comprises at least 99% elemental alkali metal by weight.

In an embodiment, the alkali metal catalyst is selected from the group consisting of lithium, sodium, potassium, rubidium, cesium, and francium. In another embodiment, the alkali metal catalyst is sodium. In yet another embodiment, the alkali metal catalyst is potassium.

In an embodiment, the alkali metal catalyst is delivered at about 110° C. In another embodiment, the alkali metal catalyst is delivered at about 100° C. In yet another embodiment, the alkali metal catalyst is delivered at about 90° C. In still another embodiment, the alkali metal catalyst is delivered at about 80° C. In an embodiment, the alkali metal catalyst is delivered at about 70° C. In another embodiment, the alkali metal catalyst is delivered at about 60° C.

In an embodiment, the catalyst dispersion contains from about 1% to about 20% metal by weight. In another embodiment, the catalyst dispersion contains from about 1% to about 10% metal by weight. In another embodiment, the catalyst dispersion contains about 1% metal by weight. In yet another embodiment, the catalyst dispersion contains about 2% metal by weight. In still another embodiment, the catalyst dispersion contains about 3% metal by weight. In an embodiment, the catalyst dispersion contains about 4% metal by weight. In another embodiment, the catalyst dispersion contains about 5% metal by weight. In yet another embodiment, the catalyst dispersion contains about 6% metal by weight. In still another embodiment, the catalyst dispersion contains about 7% metal by weight. In an embodiment, the catalyst dispersion contains about 8% metal by weight. In another embodiment, the catalyst dispersion contains about 9% metal by weight. In yet another embodiment, the catalyst dispersion contains about 10% metal by weight.

In an embodiment, step b) comprises mixing. In another embodiment, step b) comprises high shear mixing. In yet another embodiment, the high shear mixing in step b) is achieved through the use of a baffled-wall reactor and at least one impeller. In still another embodiment, the impeller is an upflow solids mixing impeller. In still another embodiment, the high shear mixing produces particles of alkali metal catalyst that have an average effective diameter of less than or equal to about 1000 μm. In an embodiment, the high shear mixing produces particles of alkali metal catalyst that have an average effective diameter of less than or equal to about 500 μm. In another embodiment, the high shear mixing produces particles of alkali metal catalyst that have an average effective diameter of less than or equal to about 250 μm. In yet another embodiment, the high shear mixing produces particles of alkali metal catalyst that have an average effective diameter of less than or equal to about 200 μm. In still another embodiment, the high shear mixing produces particles of alkali metal catalyst that have an average effective diameter of less than or equal to about 150 μm. In an embodiment, the high shear mixing produces particles of alkali metal catalyst that have an average effective diameter of less than or equal to about 125 μm. In another embodiment, the high shear mixing produces particles of alkali metal catalyst that have an average effective diameter of less than or equal to about 110 μm. In yet another embodiment, the high shear mixing produces particles of alkali metal catalyst that have an average effective diameter of less than or equal to about 100 μm. In still another embodiment, the high shear mixing produces particles of alkali metal catalyst that have an average effective diameter of less than or equal to about 90 μm. In an embodiment, the high shear mixing produces particles of alkali metal catalyst that have an average effective diameter of less than or equal to about 80 μm.

In an embodiment, the carrier fluid comprises a hydrocarbon or hydrocarbon mixture. In another embodiment, the carrier fluid has a normal boiling point in the light cycle oil to diesel boiling point range. In yet another embodiment, the hydrocarbon or hydrocarbon mixture has a normal boiling point greater than about 210° C. In still another embodiment, the hydrocarbon or hydrocarbon mixture comprises paraffins or naphthenes. In an embodiment, the carrier fluid comprises less than about 20% aromatics. In another embodiment, the carrier fluid comprises less than about 10% aromatics. In yet another embodiment, the carrier fluid comprises less than about 5% aromatics. In still another embodiment, the carrier fluid comprises less than about 1% aromatics. In an embodiment, the carrier fluid is saturated with hydrogen gas. In another embodiment, the carrier fluid is partially saturated with hydrogen gas.

In an embodiment, prior to step c), the petroleum coke particles are combined with the catalyst dispersion and the tin metal dispersion to form a coke slurry. In another embodiment, the coke slurry comprises from about 10% to about 60% petroleum liquids by weight. In yet another embodiment, the coke slurry comprises about 5% petroleum liquids by weight. In still another embodiment, the coke slurry comprises about 10% petroleum liquids by weight. In an embodiment, the coke slurry comprises about 20% petroleum liquids by weight. In another embodiment, the coke slurry comprises about 30% petroleum liquids by weight. In yet another embodiment, the coke slurry comprises about 40% petroleum liquids by weight. In still another embodiment, the coke slurry comprises about 50% petroleum liquids by weight. In an embodiment, the coke slurry comprises about 60% petroleum liquids by weight. In another embodiment, the coke slurry comprises about 70% petroleum liquids by weight. In yet another embodiment, the coke slurry comprises from about 90% to about 40% petroleum liquids by weight. In still another embodiment, the coke slurry comprises about 30% petroleum liquids by weight. In an embodiment, the coke slurry comprises about 40% petroleum liquids by weight. In another embodiment, the coke slurry comprises about 50% petroleum liquids by weight. In yet another embodiment, the coke slurry comprises about 60% petroleum liquids by weight. In still another embodiment, the coke slurry comprises about 70% petroleum liquids by weight. In an embodiment, the coke slurry comprises about 80% petroleum liquids by weight. In another embodiment, the coke slurry comprises about 90% petroleum liquids by weight.

In an embodiment, step c) is performed in a continuously stirred tank reactor. In an embodiment, step c) comprises mixing. In another embodiment, step c) comprises high shear mixing. In yet another embodiment, the high shear mixing in step c) is achieved through the use of a baffled-wall reactor and at least one impeller. In still another embodiment, the impeller is an upflow solids mixing impeller.

In an embodiment, step c) is performed at a temperature from about 300° C. to about 500° C. In another embodiment, step c) is performed at a temperature from about 370° C. to about 470° C. In yet another embodiment, step c) is performed at a temperature from about 400° C. to about 450° C. In still another embodiment, step c) is performed at a temperature of about 400° C. In an embodiment, step c) is performed at a temperature of about 410° C. In another embodiment, step c) is performed at a temperature of about 420° C. In yet another embodiment, step c) is performed at a temperature of about 430° C. In still another embodiment, step c) is performed at a temperature of about 440° C. In an embodiment, step c) is performed at a temperature of about 450° C.

In an embodiment, step c) is performed at a pressure from about 500 psig to about 3000 psig. In another embodiment, step c) is performed at a pressure from about 800 psig to about 2000 psig. In yet another embodiment, step c) is performed at a pressure of about 800 psig. In still another embodiment, step c) is performed at a pressure of about 1000 psig. In an embodiment, step c) is performed at a pressure of about 1200 psig. In another embodiment, step c) is performed at a pressure of about 1400 psig. In yet another embodiment, step c) is performed at a pressure of about 1600 psig. In still another embodiment, step c) is performed at a pressure of about 1800 psig. In an embodiment, step c) is performed at a pressure of about 2000 psig.

In an embodiment, step c) further comprises adding hydrogen gas at a partial pressure greater than or equal to about 300 psig. In another embodiment, step c) further comprises adding hydrogen gas at a partial pressure of about 300 psig. In yet another embodiment, step c) further comprises adding hydrogen gas at a partial pressure of about 350 psig. In still another embodiment, step c) further comprises adding hydrogen gas at a partial pressure of about 400 psig. In an embodiment, step c) further comprises adding hydrogen gas at a partial pressure of about 500 psig. In another embodiment, step c) further comprises adding hydrogen gas at a partial pressure of about 600 psig. In yet another embodiment, step c) further comprises adding hydrogen gas at a partial pressure of about 700 psig. In still another embodiment, step c) further comprises adding hydrogen gas at a partial pressure of about 800 psig. In an embodiment, step c) further comprises adding hydrogen gas at a partial pressure of about 900 psig. In another embodiment, step c) further comprises adding hydrogen gas at a partial pressure of about 1000 psig. In yet another embodiment, step c) further comprises adding hydrogen gas at a partial pressure of about 1500 psig. In still another embodiment, step c) further comprises adding hydrogen gas at a partial pressure of about 2000 psig. In an embodiment, step c) further comprises adding hydrogen gas at a partial pressure of about 2500 psig. In another embodiment, step c) further comprises adding hydrogen gas at a partial pressure of about 3000 psig. In yet another embodiment, step c) further comprises adding hydrogen gas at a partial pressure of about 3500 psig. In still another embodiment, step c) further comprises adding hydrogen gas at a partial pressure of about 4000 psig. In an embodiment, step c) further comprises adding hydrogen gas at a partial pressure from about 300 psig to about 4000 psig.

In an embodiment, the ratio of catalyst dispersion to petroleum coke particles in step c) is such that the molar ratio of alkali metal in the catalyst dispersion to sulfur in the petroleum coke is greater than or equal to about 2:1. In another embodiment, the ratio of catalyst dispersion to petroleum coke particles in step c) is such that the molar ratio of alkali metal in the catalyst dispersion to sulfur in the petroleum coke is about 2:1. In yet another embodiment, the ratio of catalyst dispersion to petroleum coke particles in step c) is such that the molar ratio of alkali metal in the catalyst dispersion to sulfur in the petroleum coke is about 2.5:1. In still another embodiment, the ratio of catalyst dispersion to petroleum coke particles in step c) is such that the molar ratio of alkali metal in the catalyst dispersion to sulfur in the petroleum coke is about 3:1. In an embodiment, the ratio of catalyst dispersion to petroleum coke particles in step c) is such that the molar ratio of alkali metal in the catalyst dispersion to sulfur in the petroleum coke is about 3.5:1. In another embodiment, the ratio of catalyst dispersion to petroleum coke particles in step c) is such that the molar ratio of alkali metal in the catalyst dispersion to sulfur in the petroleum coke is about 4:1. In yet another embodiment, the ratio of catalyst dispersion to petroleum coke particles in step c) is such that the molar ratio of alkali metal in the catalyst dispersion to sulfur in the petroleum coke is about 4.5:1. In still another embodiment, the ratio of catalyst dispersion to petroleum coke particles in step c) is such that the molar ratio of alkali metal in the catalyst dispersion to sulfur in the petroleum coke is about 5:1. In an embodiment, the ratio of catalyst dispersion to petroleum coke particles in step c) is such that the molar ratio of alkali metal in the catalyst dispersion to sulfur in the petroleum coke is about 5.5:1. In another embodiment, the ratio of catalyst dispersion to petroleum coke particles in step c) is such that the molar ratio of alkali metal in the catalyst dispersion to sulfur in the petroleum coke is about 6:1. In yet another embodiment, the ratio of catalyst dispersion to petroleum coke particles in step c) is such that the molar ratio of alkali metal in the catalyst dispersion to sulfur in the petroleum coke is about 6.5:1. In still another embodiment, the ratio of catalyst dispersion to petroleum coke particles in step c) is such that the molar ratio of alkali metal in the catalyst dispersion to sulfur in the petroleum coke is about 7:1. In an embodiment, the ratio of catalyst dispersion to petroleum coke particles in step c) is such that the molar ratio of alkali metal in the catalyst dispersion to sulfur in the petroleum coke is about 7.5:1. In another embodiment, the ratio of catalyst dispersion to petroleum coke particles in step c) is such that the molar ratio of alkali metal in the catalyst dispersion to sulfur in the petroleum coke is about 8:1. In yet another embodiment, the ratio of catalyst dispersion to petroleum coke particles in step c) is such that the molar ratio of alkali metal in the catalyst dispersion to sulfur in the petroleum coke is from about 1:1 to about 8:1.

In an embodiment, the conversion of petroleum coke to fluid hydrocarbons is greater than about 50% by weight. In another embodiment, the conversion of petroleum coke to fluid hydrocarbons is about 55% by weight. In yet another embodiment, the conversion of petroleum coke to fluid hydrocarbons is about 60% by weight. In still another embodiment, the conversion of petroleum coke to fluid hydrocarbons is about 65% by weight. In an embodiment, the conversion of petroleum coke to fluid hydrocarbons is about 70% by weight. In another embodiment, the conversion of petroleum coke to fluid hydrocarbons is about 80% by weight. In yet another embodiment, the conversion of petroleum coke to fluid hydrocarbons is about 85% by weight. In still another embodiment, the conversion of petroleum coke to fluid hydrocarbons is about 90% by weight. In an embodiment, the conversion of petroleum coke to fluid hydrocarbons is about 95% by weight. In another embodiment, the conversion of petroleum coke to fluid hydrocarbons is about 100% by weight.

In an embodiment, step c) reduces the sulfur content of the petroleum coke to afford desulfurized fluid hydrocarbons and sulfur byproducts. In another embodiment, the desulfurized fluid hydrocarbons do not contain detectable levels of sulfur. In yet another embodiment, the sulfur byproducts comprise less than or equal to about 0.01% H₂S by weight. In still another embodiment, the sulfur byproducts comprise about 0.01% H₂S by weight. In an embodiment, the sulfur byproducts comprise less than about 0.01% H₂S by weight. In yet another embodiment, the sulfur byproducts comprise ppb levels of H₂S by weight. In an embodiment, the sulfur byproducts comprise levels of H₂S that are not detectable.

In yet another aspect, provided herein is a process for the liquefaction of petroleum coke, the process comprising: a) providing petroleum coke that is substantially free of adsorbed water; b) grinding the petroleum coke to produce petroleum coke particles; c) providing hot alkali metal; d) combining the hot alkali metal with a carrier fluid to form an alkali metal dispersion; e) combining the alkali metal dispersion with the petroleum coke particles to form a petroleum coke slurry; f) introducing the petroleum coke slurry into a reactor; g) reacting the petroleum coke particles with the alkali metal to produce a product mixture comprising hydrocarbons and solids; h) phase-separating the product mixture to produce a solid product mixture and a hydrocarbon product mixture; and i) distilling the hydrocarbon product mixture to afford desulfurized fluid hydrocarbons.

In still another aspect, provided herein is a process for the liquefaction of petroleum coke, the process comprising: a) providing petroleum coke that is substantially free of adsorbed water; b) grinding the petroleum coke to produce petroleum coke particles; c) providing hot alkali metal; d) combining the hot alkali metal with a carrier fluid to form an alkali metal dispersion; e) providing hot tin metal; f) combining the hot tin metal with a carrier fluid to form a tin metal dispersion; g) combining the alkali metal dispersion and the tin metal dispersion with the petroleum coke particles to form a petroleum coke slurry; h) introducing the petroleum coke slurry into a reactor; i) reacting the petroleum coke particles with the alkali metal to produce a product mixture comprising hydrocarbons and solids; j) phase-separating the product mixture to produce a solid product mixture and a hydrocarbon product mixture; and k) distilling the hydrocarbon product mixture to afford desulfurized fluid hydrocarbons.

In another aspect, provided herein is a process for the liquefaction of petroleum coke, the process comprising:

a) mixing an alkali metal catalyst with a first carrier fluid to produce a catalyst dispersion;

b) optionally mixing a tin catalyst with a second carrier fluid to produce a tin dispersion;

c) optionally grinding petroleum coke to produce petroleum coke particles;

d) optionally combining the petroleum coke particles with the catalyst dispersion and/or the tin dispersion to form a coke slurry; and

e) reacting the petroleum coke particles with the catalyst dispersion and/or the tin dispersion to afford fluid hydrocarbons.

In embodiments, the petroleum coke contains less than 1% water by weight, optionally less than 0.5% water by weight. In embodiments, the petroleum coke particles have an average particle size from about 2 to about 1000 μm, optionally from about 2 to about 100 μm. In embodiments, the petroleum coke has a hydrogen to carbon molar ratio from about 0.4 to about 0.9, optionally from about 0.45 to about 0.80. In embodiments, the petroleum coke has a sulfur content from about 1% to about 10%, optionally from about 1% to about 7%.

In embodiments, the alkali metal catalyst comprises at least 90% elemental alkali metal by weight; optionally wherein the alkali metal catalyst is sodium or potassium; and/or optionally wherein the alkali metal catalyst is delivered at about 100° C. or at about 70° C.

In embodiments, the catalyst dispersion contains from about 1% to about 10% metal by weight. In embodiments, step a) comprises high shear mixing, optionally wherein the high shear mixing produces particles of alkali metal catalyst that have an average diameter of less than or equal to about 100 μm. In embodiments, the first and/or second carrier fluid comprises a hydrocarbon or hydrocarbon mixture; optionally wherein the hydrocarbon or hydrocarbon mixture has a normal boiling point greater than about 210° C.; and/or optionally wherein the hydrocarbon or hydrocarbon mixture comprises paraffins or naphthenes. In embodiments, the first and/or second carrier fluid is saturated with hydrogen gas.

In embodiments, the coke slurry comprises from about 10% to about 60% petroleum liquids by weight, or wherein the coke slurry comprises from about 90% to about 40% petroleum liquids by weight.

In embodiments, step e): optionally is performed in a continuously stirred tank reactor;

optionally comprises high shear mixing; optionally is performed at a temperature from about 370° C. to about 470° C., optionally at a temperature from about 400° C. to about 450° C.; optionally is performed at a pressure from about 300 psig to about 4000 psig, optionally at a pressure from about 800 psig to about 2000 psig; and/or optionally further comprises adding hydrogen gas at a partial pressure greater than or equal to about 300 psig.

In embodiments, the ratio of catalyst dispersion to petroleum coke particles in step e) is such that the molar ratio of alkali metal in the catalyst dispersion to sulfur in the petroleum coke is greater than or equal to about 2:1. In embodiments, the conversion of petroleum coke to fluid hydrocarbons is greater than about 50% by weight. In embodiments, step e) reduces the sulfur content of the petroleum coke to afford desulfurized fluid hydrocarbons and sulfur byproducts, optionally wherein the sulfur byproducts comprise less than or equal to about 0.01% H₂S by weight, optionally wherein the sulfur byproducts comprise levels of H₂S that are not detectable.

### EXAMPLES

### Example 1: General Procedures

### Feed Preparation

1. Dry Petroleum coke in oven ˜500-600° F. overnight
2. Analyze petroleum coke for CHNS and Calorific Value
3. Obtain C18 synthetic paraffin or equivalent. Analyze boiling point range distribution (ASTM Method D2887) and density.
4. Combine synthetic C18 paraffin (mineral oil) and petroleum coke at 30/70 weight ratio or lower to form a thick slurry. Grind avg. particle size down to ˜50-200 μm, using ball mill.
5. Measure density of slurry (g/ml)
6. Retain slurry in closed container for further batch testing

### Neutralization of Remaining (Unconverted) Petroleum Coke

1. Obtain Ethanol
2. Mix up 2 Normal HCl in an Ethanol solution
3. Titrate solids until no temperature change is detected

### Batch Test Procedures

1. Pressure test autoclave for leaks & prep unit for start-up
2. Using vacuum pump on Autoclave, pull ˜1250 mL of slurry into reactor, using funnel container
3. Using vacuum pump on Autoclave, pull ˜1250 mL of C18 synthetic paraffin feed into reactor.
4. Pressurize reactor with N2 to ˜100 psig and purge to atm ˜3 times. (Ensuring reactor is O2 free.)
5. Under inert atm, add Na in C18 mineral oil to injection device on autoclave.
6. Put on remaining insulation blankets
7. Open H2 valve & increase reactor pressure to ˜50-100 psig, and put unit on Pressure control using split-range & slow H2 blead (˜50 mL/min).
8. Start mixer impeller at ˜600 RPM.
9. Turn on all heat tracing & set control for ˜150° C. target.
10. Check unit for leaks using HC sniffer & tighten fittings if needed.
11. Increase heaters to ˜250° C., and continue to monitor for leaks.
12. Increase pressure controller to ˜1000 psig.
13. Increase H2 flow to bottom of unit at ˜4 L/min.
14. Slowly inject Na into autoclave, using ˜1500 psig N2 feed.
15. Record temps & Monitor torque on Impeller overtime (either via torque or amp meter)
16. Bring Pressure & Temps up to target operating conditions: ˜1500 psig & ˜350° C.

17. Hold for ˜2-4 hours.
18. Cut off heat & continue mixing & H2 injection.
19. Decrease cooling loop pressure (if possible) for increased cooling rate.
20. Decrease reactor pressure
21. Remove insulating blankets
22. As temperatures reach ˜150 C, cut H2 flow and decrease impeller speed.
23. Obtain ambient temps & decrease unit pressure to atmospheric.
24. Pressure up reactor ˜3-4 times to ˜100-150 psig using N2 to purge reactor OH space.
25. Set unit at ˜0 psig
26. Using separate injection valve, slowly add ˜10× stoichiometric EtOH to Na originally added.
27. Mix reactor for ˜30 min at ˜500 rpm
28. Slowly inject ˜200 mL of water
29. Mix reactor for another 30 min
30. Stop impeller

### Samples & Analytical

1. Collect all Overhead condensed liquids—weigh, run distillation (D2887), & density.
2. Remove solids from Aqueous & HC phase
3. Filter solids from liquids—weigh wet & dry solids.
4. Wash Solids with ˜100 mL EtOH
5. Wash Solids with ˜200 mL water
6. Dry solids ˜500° F.
7. Analyze Solids for CHNS & Calorific value
8. Measure total Liquids weight collected from reactor
9. Add both the EtOH & water decant to collected mixed liquid
10. Decant Aqueous phase from HC phase & weigh
11. Measure HC liquid Density, Distillation
12. Keep retains—Coke & HC phase

### Measure

1. Solids conversion
2. Solids CHN content difference
3. What type of liquid HC's were produced
4. Experiment MB Closure

### Example 2: Hydroliqufaction of Petroleum Coke Using an Alkali Metal Catalyst

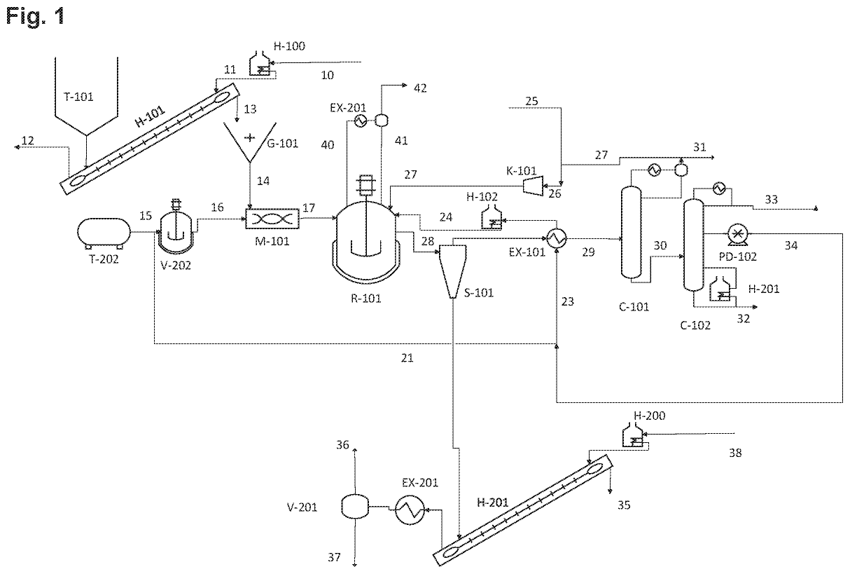

The process described herein is presented in schematic form in FIG. 1. The petroleum coke feed, coming from typical delayed coking operations or Flexicoking™ operations, is loaded into tank T-101. This material is dried using kiln, H-101, wherein inert, dry gas (10) is preheated using heater H-100 and introduced counter-current to the flow of petroleum coke. Dried petroleum coke, primarily free of adsorbed water, exits the operation as Stream 13. Inert gas containing water exits as stream 12. The inert gas may be optionally cooled, dehydrated, and compressed back to H-100 (not shown in FIG. 1).

The dry petroleum coke can then be introduced into a grinder G-101, used to size the material prior to reaction. Because reactions primarily take place on the surface of the petroleum coke, it is desired to reduce the size of the petroleum coke down to 2-1000 um and more preferably down to 2-100 um average particle size. Sized, dried petroleum coke exits the grinder as Stream 14.

In a separate vessel, T-202, hot alkali metal is stored. This material is typically shipped to the plant in rail-cars or isotainers and is maintained at temperatures above the melting point of the alkali metal. Typically, sodium is stored slightly above 100° C. and potassium is stored slightly above 70° C.

A dispersion of alkali metal is then produced by mixing the alkali metal with hydrocarbons, typically in the light cycle oil to diesel boiling point range. This diesel or light cycle oil is to be substantially hydrotreated material, shown as stream 2, a recycle stream coming from distillation tower C-102. Alternatively, this material can come from a separate hydrotreating operation (not depicted). The hydrotreated cycle oil is added as the continuous phase along with the alkali metal as the dispersed phase and mixed under high shear conditions in V-202. A targeted dispersed alkali drop size of between 1-1000 μm is achieved, with a drop size of between 1-100 um being preferable.

Typically, alkali metal represents between 1-10% by weight of the mixture and hydrotreated hydrocarbons represent 99-90% weight.

Alkali metal dispersion exits V-202 as stream 16 and then mixed with the ground petroleum coke, stream 14, using mixer M-101. Therein, a thick slurry of petroleum coke, alkali metal, and hydrocarbons is produced. The resulting slurry (17) is then pumped (not shown) and introduced continuously into reactor, R-101. The slurry is maintained at temperatures below the reactor temperature, and preferably below 350 C to minimize reactions prior to introduction into the reactor.

The slurry maybe composed of between 10% weight petroleum coke/90% hydrocarbon dispersion and up to 60% wt petroleum coke slurry/40% hydrocarbon dispersion prior to introduction into the reactor, and one or more reactors may be used in cascade.

R-101 is a continuously stirred tank reactor, containing injection nozzles and at least one impeller for the mixing of solids with liquid and gases (hydrogen) with liquid. The CSTR design can comprise both gas injection impellers and impellers such as anchors for mixing of solids. The CSTR design can comprise baffled walls to increase shear between the solids and liquid phases.

Overall the hydrotreating reactions are exothermic. Heat can be managed through the boiling of the hydrocarbon phase and condensing using EX-201. System pressure is adjusted to manage the desired reaction temperature. Target temperature for the process is greater than 380° C. and as high as 470° C. More preferably the operating temperature is between 400-450° C. Target operating pressure is between 500 psig & 3000 psig, and more preferably between 800-2000 psig. Cooled recovered hydrocarbons exit condenser EX-201 and are sent back to the reactor via stream 41.

Additional hot, hydrotreated solvent hydrocarbon may be sent into to the reactor via Stream 24, in order to manage the overall reactor solids/liquids ratios. Hydrogen is introduced into the reactor via stream 27.

Target fresh alkali metal to petroleum coke sulfur level is maintained at 2:1 Na:S and above, and more preferably above 3:1 Na:S. This assumes available oxygen in the feed is minimal, which is the case for kiln dried petroleum coke.

A mixed hydrocarbon/solids product exits the reactor as stream 28 and is phase separated using S-101, which may be comprised of filters, centrifuges, cyclones, and other solids/liquid separations devices. The substantially solids-free liquid stream is sent to EX-101, which may be include any set of heat exchangers used for product heat recovery. The remaining solids phase from S-101 is sent to kiln H-201, where hot gas (30) is used to counter-currently dry the remaining solids. Dried solids substantially higher in oxygen than the petroleum coke feed exit H-201 kiln as stream 35. Exiting gas from the kiln may be cooled using EX-201, for liquids recovery via stream 37. Additionally, exit gas 36 may be further cooled and recycled back for reuse as feed to H-200 (not shown).

Partially cooled effluent from EX-101 exits as stream 29 and is introduced into a stabilizing distillation column, C-101, for removal of hydrogen and other light ends. The overhead system of this distillation column will involve a partial condenser operation, where light liquids and light gas may be recovered. The uncondensed light gas containing recovered hydrogen exits as stream 27 and may be sent back to the reactor via stream 27. Column pressure may be maintained via using a non-condensible purge stream 31. Fresh hydrogen maybe introduced into the reactor via stream 25 and compressor K-101.

After stabilization, the hydrocarbon solvent maybe recovered from the remaining heavier liquefaction products, using C-102. A simplistic version of C-102 is depicted in FIG. 1, whereby a single light product with boiling points lower than diesel are recovered as overheads (stream 33) and whereby a single mid-tower draw is depicted (stream 34), for the solvent recovery. Liquefied heavy and partially desulfurized product exits as stream 32. The column reboiler is maintained via heat from fired furnace H-201. As is known by those skilled-in-the-art, a multitude of alternative column distillation designs may be provided for better heat integration, with intermediate pump-arounds and recovery of multiple products. Herein, C-201 represents only a simplistic version, showing the objective to recover the solvent cut for use as recycle to R-101.

### Example 3: Hydroliquefaction of Petroleum Coke Using an Alkali Metal Catalyst and a Tin Co-Catalyst

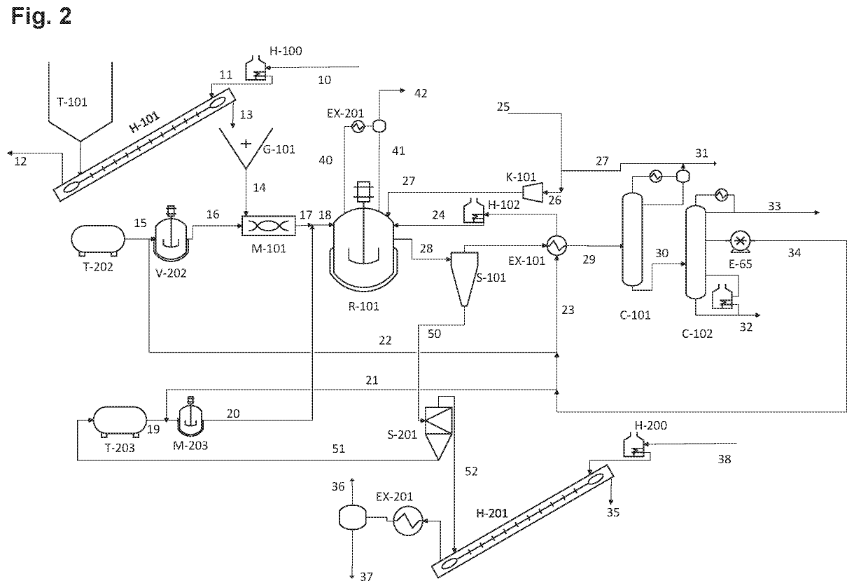

The process described herein is presented in schematic form in FIG. 2. FIG. 2 is essentially the same as FIG. 1, with the exception that now molten tin metal may be introduced into R-101. As depicted, molten tin is stored in tank T-203 at temperatures of approximately 250 C. Such temperatures may be maintained using external heating (not depicted).

Similar to the formation of alkali metal dispersion as discussed above, a dispersion of tin in solvent hydrocarbons is produced by the mixing of molten tin from stream 19 with a portion of recycle solvent (stream 21). Mixer M-203 is utilized to produce a tin dispersed-phase mixture, which is subsequently introduced into reactor R-101, via stream 20.

Upon reaction, molten tin does not form a significant quantity of intermediates and maybe recovered and recycled for further use. This is managed through the addition of separator S-201. Feed for S-201 comes from S-101, whereby both tin and partially converted petroleum coke exit the bottom as a heavy liquid/solids stream. The heavy liquid/petroleum coke solids mixture is then separated in S-201, where petroleum coke solids is separated using settling equipment useful for separation by gravity. By maintaining the level of this system, the heavy tin phase is settled out and away from the lighter solids fraction. As part of this system (not shown), pressure can be reduced to allow for vaporization and recovery of the hydrocarbon liquids absorbed in the remaining hydrocarbon solids. Settled tin is sent back to hot storage for reuse via stream 51. Residual petroleum coke solids are sent to kiln H-201 for removal of liquid hydrocarbons.

It is envisioned that the alkali metals constituents, which remain within the unconverted hydrocarbon material (stream 35), may be separated using a subsequent process to produce an alkali sulphide or poly alkali sulphide melt phase which can be separated from any carbonaceous solids.

### Example 4: Impact of Temperature with Paraffinic Solvent Exxsol at 2:1 Na:S Molar Ratio

| solvent | Exxsol | Exxsol | Exxsol |
|---|---|---|---|
| Temp/C. | 300 | 340 | 380 |
| Na:S | 2 | 2 | 2 |
| Petroleum coke % | 30 | 30 | 30 |
| Hydrogen P/barg | 100 | 100 | 100 |
| Time/hrs | 6 | 6 | 6 |
| Wt/g | 1000 | 1000 | 1000 |
| Conversion/% | 6.36 | 12.13 | 15.47 |

The data presented in this table clearly show the increase in petroleum coke conversion with increasing temperature from 6.36% at 300 C to 15.47% at 380 C with the paraffinic Exxsol™ solvent.

### Example 5: Comparison of Exxsol with Tetralin Solvent at 380° C.

| solvent | Exxsol | Tetralin |
|---|---|---|
| Temp/C. | 380 | 380 |
| Na:S | 2 | 2 |
| Petroleum coke % | 30 | 30 |
| Hydrogen P/barg | 100 | 100 |
| Time/hrs | 6 | 6 |
| Wt/g | 1000 | 1000 |
| Conversion/% | 15.47 | 13.85 |

The data presented in this table clearly show little change in conversion with hydrogen donating solvent over paraffinic in a like-for-like comparison. The purpose of this experiment was to determine if there would be large conversion changes due to the type of solvent used.

### Example 6: Impact of Temperature with Tetralin Solvent at 2:1 Na:S Molar Ratio

| solvent | Tetralin | Tetralin |
|---|---|---|
| Temp/C. | 380 | 360 |
| Na:S | 2 | 2 |
| Petroleum coke % | 30 | 30 |
| Hydrogen P/barg | 100 | 100 |
| Time/hrs | 6 | 6 |
| Wt/g | 1000 | 1000 |
| Conversion/% | 13.85 | 8.00 |

The data in this table show the decrease in petroleum coke conversion with decreasing reactor temperature with the hydrogen-donating tetralin solvent.

### Example 7: Impact of Na:S Molar Ratio

| solvent | Tetralin | Tetralin |
|---|---|---|
| Temp/C. | 380 | 380 |
| Na:S | 2 | 4 |
| Petroleum coke % | 30 | 30 |
| Hydrogen P/barg | 100 | 100 |
| Time/hrs | 6 | 6 |
| Wt/g | 1000 | 1000 |
| Conversion/% | 13.85 | 23.47 |

The data in this table show an increase in petroleum coke conversion with increasing Na:S molar ratio from 13.85% at a 2:1 Na:S molar ratio to 23.47% with 4:1 Na:S molar ratio. The second column indicates an increase in hydrotreatment due to having more available Na.

### Example 8: Impact of Reduced Petroleum Coke Loading at 4:1 Na:S Molar Ratio

| solvent | Tetralin | Tetralin |
|---|---|---|
| Temp/C. | 420 | 420 |
| Na:S | 4 | 4 |
| Petroleum coke % | 30 | 10 |
| Hydrogen P/barg | 100 | 100 |
| Time/hrs | 6 | 6 |
| Wt/g | 1000 | 1000 |
| Conversion/% | 24.05 | 52.1 |

The data in this table show an increase in petroleum coke conversion with reduced petroleum coke loading at 420° C. with tetralin. The second column illustrates the challenges with dealing with higher solids loading.

### Example 9: Impact of Reduced Hydrogen Partial Pressure

| solvent | Tetralin | Tetralin |
|---|---|---|
| Temp/C. | 420 | 420 |
| Na:S | 4 | 4 |
| Petroleum coke % | 10 | 10 |
| Hydrogen P/barg | 100 | 100 (50) |
| Time/hrs | 6 | 6 |
| Wt/g | 1000 | 1000 |
| Conversion/% | 52.1 | 43.8 |

The data in this table show a decrease in petroleum coke conversion with reduced hydrogen partial pressure (50 barg) at 420 C with tetralin at 100 barg reactor pressure. The second column provides insight into the effect of hydrogen partial pressures on overall hydrotreating and illustrates that some mass transfer resistances and/or the different types of component hydrotreating which may exist, which effect the overall reaction kinetics.

### Example 10: Impact of Tin Co-Catalyst at 4:1 Na:S Molar Ratio

| solvent | Tetralin | Tetralin |
|---|---|---|
| Temp/C. | 420 | 420 |
| Na:S | 4 | 4 |
| Petroleum coke % | 30 | 30 |
| Sn:petroleum coke | 0 | 10 |
| % | | |
| Hydrogen P/barg | 100 | 100 |
| Time/hrs | 6 | 6 |
| Wt/g | 1000 | 1000 |
| Conversion/% | 24.05 | 46.3 |

The data presented in this table show an increase in petroleum coke conversion using a 10% tin co-catalyst at 30% petroleum coke loading. The second column illustrates how tin can be leveraged to help the overall reaction kinetics.

### Example 11: Impact of Different Agitation at 4:1 Na:S Molar Ratio and 10% Petroleum Coke Loading

| | Down-pumping 8 | Up-lifting |
|---|---|---|
| | blade turbine, | anchor agitator, |
| Agitator | 1000 rpm | 250 rpm |
| solvent | Tetralin | Tetralin |
| Temp/C. | 420 | 420 |
| Na:S | 4 | 4 |
| Petroleum coke % | 10 | 10 |
| Sn:petroleum coke | 0 | 0 |
| % | | |
| Hydrogen P/barg | 100 | 100 |
| Time/hrs | 6 | 6 |
| Wt/g | 1000 | 1000 |
| Conversion/% | 52.1 | 67.9 |

The data in this table show an increase in petroleum coke conversion using an up-lifting anchor agitator at 250 rpm. All previous examples used a down-pumping 8-blade turbine agitator at 1000 rpm. The second column illustrates how one can manage the mass transfer challenges.

### Example 12: Impact of Temperature on Petroleum Coke % S and Hydrogen:Carbon Ratio

| | Petroleum | | | | | |
|---|---|---|---|---|---|---|
| | coke | 320° C. | 340° C. | 360° C. | 380° C. | 400° C. |
| solvent | None | Exxsol | Exxsol | Exxsol | Exxsol | Exxsol |
| Temp/C. | N/A | 320 | 340 | 360 | 380 | 400 |
| Na:S | N/A | 2 | 2 | 2 | 2 | 2 |
| Petroleum coke | 100 | 30 | 30 | 30 | 30 | 30 |
| % | | | | | | |
| Hydrogen P/barg | N/A | 100 | 100 | 100 | 100 | 100 |
| Time/hrs | N/A | 6 | 6 | 6 | 6 | 6 |
| Wt/g | N/A | 1000 | 1000 | 1000 | 1000 | 1000 |
| H/C | 0.489 | 0.635 | 0.532 | 0.533 | 0.629 | 0.629 |
| % S | 7.0 | 5.1 | 5.4 | 5.5 | 5.2 | 4.9 |

The disclosed subject matter is not to be limited in scope by the specific embodiments and examples described herein. Indeed, various modifications of the disclosure in addition to those described will become apparent to those skilled in the art from the foregoing description and accompanying figures. Such modifications are intended to fall within the scope of the appended claims.

All references (e.g., publications or patents or patent applications) cited herein are incorporated herein by reference in their entirety and for all purposes to the same extent as if each individual reference (e.g., publication or patent or patent application) was specifically and individually indicated to be incorporated by reference in its entirety for all purposes. Other embodiments are within the following claims.

1. A process for the liquefaction of petroleum coke, the process comprising:
a) mixing an alkali metal catalyst with a carrier fluid to produce a catalyst dispersion; and
b) reacting petroleum coke particles with the catalyst dispersion to afford fluid hydrocarbons.

2. The process of claim 1, the process further comprising grinding petroleum coke to produce petroleum coke particles with an average particle size from about 2 to about 1000 μm.

3. The process of claim 2, wherein the petroleum coke contains less than 1% water by weight.

4. The process of claim 2, wherein the petroleum coke has a hydrogen to carbon molar ratio from about 0.4 to about 0.9.

5. The process of claim 2, wherein the petroleum coke has a sulfur content from about 1% to about 10%.

6. The process of claim 1, wherein the alkali metal catalyst comprises at least 90% elemental alkali metal by weight.

7. The process of claim 1, wherein the alkali metal catalyst is sodium or potassium.

8. The process of claim 7, wherein the alkali metal catalyst is delivered at about 100° C. or at about 70° C.

9. The process of claim 1, wherein the catalyst dispersion contains from about 1% to about 10% metal by weight.

10. The process of claim 1, wherein the catalyst dispersion further comprises a tin catalyst.

11. The process of claim 1, wherein step a) comprises high shear mixing to produce particles of alkali metal catalyst that have an average diameter of less than or equal to about 100 μm.

12. The process of claim 1, wherein the carrier fluid comprises a hydrocarbon or hydrocarbon mixture, the hydrocarbon or hydrocarbon mixture comprising paraffins or naphthenes having a normal boiling point greater than about 210° C.

13. The process of claim 1, wherein the carrier fluid is saturated with hydrogen gas.

14. The process of claim 1, wherein prior to step b), the petroleum coke particles are combined with the catalyst dispersion to form a coke slurry.

15. The process of claim 14, wherein the coke slurry comprises from about 10% to about 60% petroleum liquids by weight.

16. The process of claim 1, wherein step b) is performed at a temperature from about 370° C. to about 470° C.

17. The process of claim 1, wherein step b) further comprises adding hydrogen gas at a partial pressure greater than or equal to about 300 psig.

18. The process of claim 1, wherein the ratio of catalyst dispersion to petroleum coke particles in step b) is such that the molar ratio of alkali metal in the catalyst dispersion to sulfur in the petroleum coke is greater than or equal to about 2:1.

19. The process of claim 1, wherein step b) reduces the sulfur content of the petroleum coke to afford desulfurized fluid hydrocarbons and sulfur byproducts.

20. A process for the liquefaction of petroleum coke, the process comprising:
a) mixing an alkali metal catalyst with a first carrier fluid to produce a catalyst dispersion;
b) mixing a tin catalyst with a second carrier fluid to produce a tin dispersion; and
c) reacting petroleum coke particles with the tin dispersion and the catalyst dispersion to afford fluid hydrocarbons.
